(19) United States
(12) Patent Application Publication
(10) Pub. No.: US 2026/0342963 A1
(43) Pub. Date: Oct. 29, 2026

(54) PREDICTION GENERATION WITH OUT-OF-BOUNDARY CHECK IN VIDEO CODING

(71) Applicant: MEDIATEK INC., Hsinchu City (TW)

(72) Inventors: Yu-Ling HSIAO, Hsinchu City (TW); Chih-Wei HSU, Hsinchu City (TW); Yu-Wen HUANG, Hsinchu City (TW)

(21) Appl. No.: 18/881,065

(22) PCT Filed: Jun. 5, 2023
(86) PCT No.: PCT/CN2023/098287

§ 371 Date: Jan. 3, 2025

Related U.S. Application Data
(60) Provisional application No. 63/367,738, filed on Jul. 6, 2022.

(51) Int. Cl. H04N 19/105; H04N 19/167; H04N 19/176; H04N 19/593

(52) U.S. Cl. CPC H04N 19/105; H04N 19/167; H04N 19/176; H04N 19/593

(57) ABSTRACT

A method of coding video pictures using predictive coding with out-of-bound (OOB) checks is provided. A video coder receives data to be encoded or decoded as a current block of a current picture of a video. The video coder identifies a first reference block in a first reference picture based on a first block vector of the current block and a second reference block in a second reference picture based on a second block vector of the current block. The video coder performs out-of-bound (OOB) check for the first and second reference blocks. The video coder generates a predictor for the current block based on the first and second reference blocks and based on the OOB check, such that the use of bi-directional motion compensation can be constrained. The video coder encodes or decodes the current block by using the generated predictor.

### CROSS REFERENCE TO RELATED PATENT APPLICATION(S)

The present disclosure is part of a non-provisional application that claims the priority benefit of U.S. Provisional Patent Application No. 63/367,738, filed on 6 Jul. 2022. Contents of above-listed application is herein incorporated by reference.

### TECHNICAL FIELD

The present disclosure relates generally to video coding. In particular, the present disclosure relates to methods of coding pixel blocks by inter- and intra-prediction.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method of coding video pictures using predictive coding with out-of-bound (OOB) checks. A video coder receives data to be encoded or decoded as a current block of a current picture of a video. The video coder identifies a first reference block in a first reference picture based on a first block vector of the current block and a second reference block in a second reference picture based on a second block vector of the current block. The video coder performs out-of-bound (OOB) check for the first and second reference blocks. The video coder generates a predictor for the current block based on the first and second reference blocks and based on the OOB check. The video coder encodes or decodes the current block by using the generated predictor.

The first and second block vectors may be motion vectors. In some embodiments, the first reference picture or the second reference picture is the current picture, and the first block vector or the second block vector is an intra-prediction direction or mode.

In some embodiments, when a sample of the first reference block is OOB, a bi-directional motion compensation is not applied to at least one of a horizontal direction and a vertical direction. In some embodiments, when a sample of the first reference block is OOB over a left or right boundary of the first reference picture or when a sample of the first reference block is OOB over a top or bottom boundary of the first reference picture, the bi-directional motion compensation is not applied. In some embodiments, when a sample of the first reference block is a non-OOB sample, a corresponding predictor sample is generated by blending the non-OOB sample of the first reference block with a corresponding non-OOB sample of the second reference block. When a sample of the first reference block is a OOB sample, a corresponding predictor sample is generated by using a corresponding non-OOB sample of the second reference block without blending.

In some embodiments, the video may be a 360-degree video in an equi-rectangular projection (ERP) format. When a sample of the first reference block is OOB over a left or right boundary of the first reference picture, a corresponding predictor sample is generated by blending a horizontal wrap-around sample from the first reference picture with a corresponding non-OOB sample from the second reference block in the second reference picture. When a sample of the first reference block is OOB over a top or bottom boundary of the first reference picture, a corresponding predictor sample is generated by using a corresponding non-OOB sample from the second reference block without blending.

In some embodiments, the current block is partitioned into multiple geometric partitions, the first reference block is used to generate a first predictor for a first geometric partition and the second reference block is used to generate a second predictor for a second geometric partition. A corresponding predictor sample is generated by blending samples of the first and second predictors along a boundary between the first and second geometric partitions, with out-of-bound samples of the first and second predictors excluded from the blending.

In some embodiments, the generated predictor is a combined inter-intra prediction (CIIP), wherein the first reference block provides inter-prediction samples and the second reference block provide intra-prediction samples. In some embodiments, the current block is coded using multi-hypothesis prediction (MHP), such that the encoder performs an additional OOB check for a third reference block, and the predictor is generated further based on the third reference block and the additional OOB check.

In some embodiments, the first block vector is refined to minimize a calculated template matching cost between a reference template neighboring the first reference block and a current template neighboring the current block, with OOB samples of the reference template excluded from the cost calculation. In some embodiments, the first and second block vectors are refined to minimize a bilateral matching cost based on the first and second reference blocks, with OOB samples in the first and second reference blocks excluded from the cost calculation.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates bi-directional prediction with out-of-bound (OOB) reference blocks.

FIG. 2 conceptually illustrates multiple hypothesis prediction (MHP) for coding a current block.

FIG. 3 illustrates the partitioning of a coding unit (CU) by the geometric partitioning mode (GPM).

FIG. 4 illustrates an example uni-prediction candidate list for a GPM partition and the selection of a uni-prediction MV for GPM.

FIG. 5 illustrates an example partition edge blending process for GPM for a CU.

FIG. 6 conceptually illustrates performing template matching based on a search area around an initial motion vector (MV).

FIG. 7 conceptually illustrates a current block having sub-block motion.

FIG. 8 conceptually illustrates refinement of a prediction candidate by bilateral matching (BM).

FIG. 9 shows the intra-prediction modes in different directions.

FIGS. 10A-B conceptually illustrate top and left reference templates with extended lengths for supporting wide-angular direction mode for non-square blocks of different aspect ratios.

FIGS. 11A-C conceptually illustrate horizontal wrap-around motion compensation with out-of-boundary (OOB) checks.

FIG. 12 conceptually illustrates intra prediction with OOB reference samples.

FIG. 13 illustrates an example video encoder that may implement predictive coding.

FIG. 14 illustrates portions of the video encoder that implement out-of-bound checks for predictive coding.

FIG. 15 conceptually illustrates a process for using out-of-bound checks for predictive coding of a block of pixels.

FIG. 16 illustrates an example video decoder that may implement predictive coding.

FIG. 17 illustrates portions of the video decoder that implement out-of-bound checks for predictive coding.

FIG. 18 conceptually illustrates a process for using out-of-bound checks for predictive coding of a block of pixels.

FIG. 19 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Out-of-Boundary Check for Motion Compensation

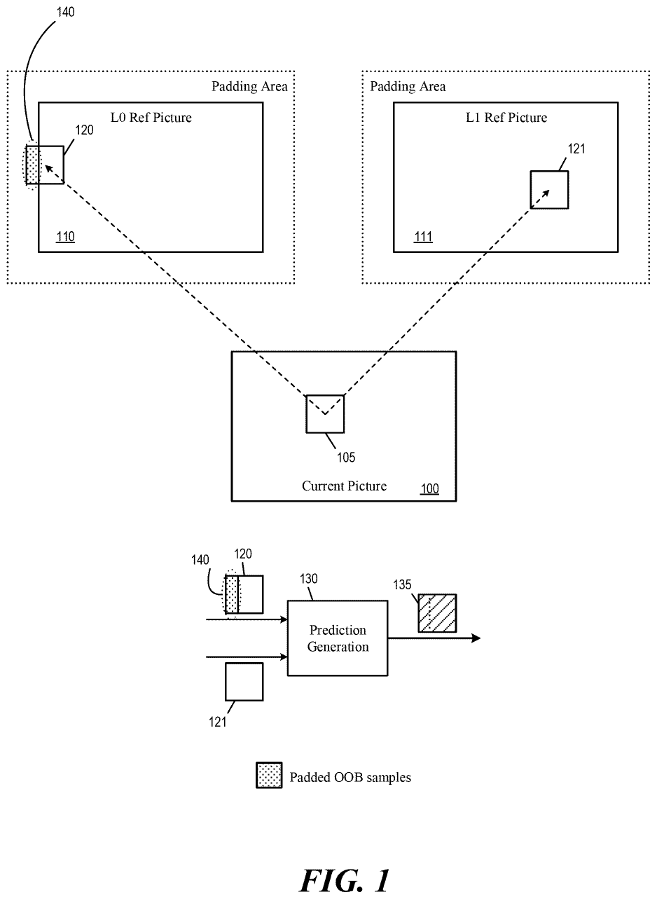

It is possible for an inter-predicted CU to have a reference block located outside the reference picture partially or totally. FIG. 1 illustrates bi-directional prediction with out-of-boundary (OOB) reference blocks. In the FIGURE, bi-directional motion compensation is performed to generate an inter prediction block (predictor) of a current block 105 in a current picture 100. A list 0 reference block 120 is partially out-of-boundary (OOB) of a reference picture 110. A list 1 reference block 121 is fully inside a reference picture 111. The OOB portion 140 of the reference block 120 is filled with repetitive padding samples when the video coder performing a prediction generation process 130. The prediction generation process 130 uses the reference blocks 120 and 121 to generate a prediction block 135 for the current block 105. Since the OOB portion 140 of the reference block 120 is padded with repetitive samples derived from the boundary samples within the reference picture 110, the part of a motion compensated block 135 that correspond to the OOB portion 140 may provide less prediction efficiency.

In some embodiments, a uni-directional motion compensated sample is regarded as OOB when one of its reference samples is located outside the reference picture beyond half sample. For each prediction sample in a bi-directional motion compensated block, when one of its uni-directional prediction samples is OOB and the other one is non-OOB, the corresponding bi-directional sample is set equal to the non-OOB sample instead of using an average of the OOB and non-OOB samples.

In some embodiments, when combining more than one prediction blocks, the OOB prediction samples are discarded, and only the non-OOB predictors are used to generate the final predictor. Specifically, let Pos_x_{i,j} and Pos_y_{i,j} denote the x and y positions of one prediction sample (i, j) in one current block, and MV^{LX}_x_{i,j} and MV^{LX}_y_{i,j} (LX=L0 or L1) denote the MV of the current block; Pos_{LeftBdry}, Pos_{RightBdry}, Pos_{TopBdry}, Pos_{BottomBdry} are the positions of four boundaries of the picture. One prediction sample is regarded as OOB when at least one of the following conditions is satisfied:

(Pos_x_{i,j}+MV^{LX}_x_{i,j})>(Pos_{RightBdry}+half_pixel),

(Pos_x_{i,j}+MV^{LX}_x_{i,j})<(Pos_{LeftBdry}+half_pixel),

(Pos_y_{i,j}+MV^{LX}_y_{i,j})>(Pos_{BottomBdry}+half_pixel),

(Pos_y_{i,j}+MV^{LX}_y_{i,j})>(Pos_{TopBdry}+half_pixel)
where half_pixel is equal to 8 that represents the half-pel sample distance in the 1/16-pel sample precision. After examining the OOB condition for each sample, the final prediction samples of one bi-directional block is generated as follows:
If P^{L0}_{i,j} is OOB and P^{L1}_{i,j} is non-OOB, then p^{final}_{i,j}=P^{L1}_{i,j}
else if P^{L0}_{i,j} is non-OOB and P^{L1}_{i,j} is OOB, then p^{final}_{i,j}=P^{L0}_{i,j}
else p^{final}_{i,j}=(P^{L0}_{i,j}+P^{L1}_{i,j}+1)»1

### II. Block Coding Prediction Tools

a. Horizontal Wrap Around Motion Compensation

The horizontal wrap around motion compensation is a 360-specific coding tool designed to improve the visual quality of reconstructed 360-degree video in an equi-rectangular projection (ERP) format. In conventional motion compensation, when a motion vector refers to samples beyond the picture boundaries of the reference picture, repetitive padding is applied to derive the values of the out-of-bounds samples by copying from those nearest neighbors on the corresponding picture boundary. For 360-degree video, this method of repetitive padding is not suitable, and may cause visual artefacts called “seam artefacts” in a reconstructed viewport video. Because a 360-degree video is captured on a sphere and inherently has no “boundary,” the reference samples that are out of the boundaries of a reference picture in the projected domain can always be obtained from neighboring samples in the spherical domain.

For a general projection format, it may be difficult to derive the corresponding neighboring samples in the spherical domain, because doing so involves 2D-to-3D and 3D-to-2D coordinate conversion, as well as sample interpolation for fractional sample positions. This problem is much simpler for the left and right boundaries of the ERP projection format, as the spherical neighbors outside of the left picture boundary can be obtained from samples inside the right picture boundary, and vice versa. Thus, the horizontal wrap around motion compensation can be used to improve the visual quality of 360-video coded in the ERP projection format.

In some embodiments, the horizontal wrap around motion compensation can be combined with the (non-normative) padding method often used in 360-degree video coding. This may be achieved by signaling a high-level syntax element to indicate the wrap-around offset, which may be set to the width of padding applied to the ERP picture. This syntax may be used to adjust the position of horizontal wrap around accordingly. This syntax is not affected by the specific amount of padding on the left and right picture boundaries, and therefore naturally supports asymmetric padding of the ERP picture, i.e., when left and right padding are different. The horizontal wrap around motion compensation provides more meaningful information for motion compensation when the reference samples are outside of the reference picture's left and right boundaries.

b. Multi-Hypothesis Prediction (MHP)

In the multi-hypothesis inter prediction mode (MHP), one or more additional motion-compensated prediction signals are signaled, in addition to the conventional Bi-prediction signal. The resulting overall prediction signal is obtained by sample-wise weighted superposition. With the bi prediction signal p_{bi} and the first additional inter prediction signal/hypothesis h₃, the resulting prediction signal p₃ is obtained according to

p₃=(1−α)p_{bi}+αh₃

The weighting factor α (or blending ratio) is specified by a syntax element add_hyp_weight_idx in the coded video to be ¼ or −⅛, etc.

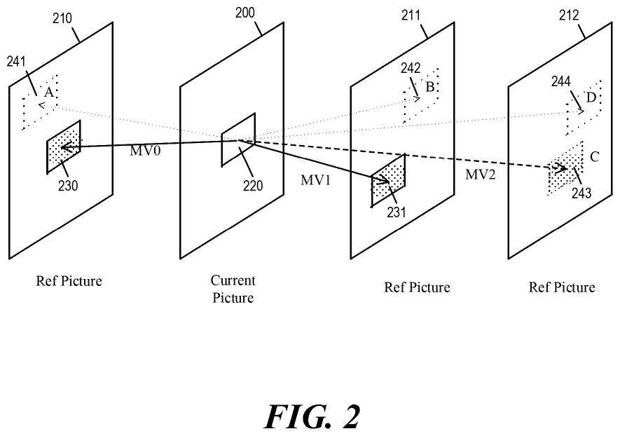

FIG. 2 conceptually illustrates multiple hypothesis prediction (MHP) for coding a current block 220. The current block 220 is in a current picture 200. The current block has bi-prediction motion vectors MV0 and MV1 for fetching predictors 230 (in reference picture 210) and 231 (in reference picture 211), respectively. The bi-prediction predictors are used to generate the bi-prediction signal p_{bi}. In addition to the bi-prediction, the current block is coded by using MHP prediction. The MHP prediction is based on an additional hypothesis selected from several MHP candidates A, B, C, and D, which respectively locate predictors or prediction signals 241, 242, 243, and 244 in different reference pictures. In the example, the hypothesis C is selected to generate the additional prediction signal h₃, which is prediction signal 243.

In some embodiments, more than one additional prediction signal can be used. The resulting overall prediction signal is accumulated iteratively with each additional prediction signal. For example, a second additional hypothesis h₄ can be added to the prediction according to:

p₄=(1−α)p₃+αh₄

or more generally:

pₙ₊₁=(1−αₙ₊₁)pₙ+αₙ₊₁hₙ₊₁

The resulting prediction signal pₙ₊₁ is obtained as a blending result of the last pₙ (currently accumulated prediction) and the newest additional prediction signal hₙ₊₁. The first existing prediction of the current block is po. For example, if MHP is applied to a merge candidate, po is indicated with the existing merge index. The blending of hₙ₊₁ and pₙ₊₁ is a weighted sum based on a blending ratio or weighting factor α. In some embodiments, for each additional hypothesis of the prediction, a weighting index may be signaled/parsed to indicate the weighting factor.

c. Combined Inter and Intra Prediction (CIIP)

The Combined inter and intra prediction (CIIP) combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode or the one or more intra prediction modes derived from a pre-defined mechanism. For example, in the following, the pre-defined mechanism is based on the neighboring reference regions (template) of the current block. The intra prediction mode of a CU is implicitly derived by a neighboring template at both encoder and decoder, instead of being signalled as the exact intra prediction mode bits to the decoder. The prediction samples of the template are generated using the reference samples of the template for each candidate mode. A cost is calculated as the SATD between the prediction and the reconstruction samples of the template. The intra prediction mode with the minimum cost and/or some intra prediction modes with the smaller costs are selected and used for intra prediction of the CU. The candidate modes may be all MPMs and/or any subset of MPMs, 67 intra prediction modes as in VVC or extended to 131 intra prediction modes. The intra and inter prediction signals are combined using weighted averaging, where the weight value is calculated depending on the coding modes of the top and left neighbouring blocks. The CIIP prediction Pomp is formed as follows: (wt is the weight value)

P_{CIIP}=((4−wt)*Pᵢₙₜₑᵣ+wt*Pᵢₙₜᵣₐ+2)»2

In some embodiments, when a CU is coded in merge mode, if the CU contains at least 64 luma samples (that is, CU width times CU height is equal to or larger than 64), and if both CU width and CU height are less than 128 luma samples, an additional flag may be signaled to indicate if CIIP mode is applied to the current CU.

d. Geometric Partitioning Mode (GPM)

Geometric partitioning mode is a coding tool for inter prediction that partitions the current block being coded into two or more parts. Each GPM partitioning or GPM split is a partition mode characterized by a distance-angle pairing that defines a bisecting or segmenting line. The geometric partitioning mode (GPM) is signalled using a CU-level flag as one kind of merge mode, with other merge modes that includes the regular merge mode, the MMVD mode, the CIIP mode, and the subblock merge mode. In total 64 partition modes are supported by geometric partitioning mode for each possible CU size w×h=2^{m}×2ⁿ with m,n∈{3 . . . 6} excluding 8×64 and 64×8.

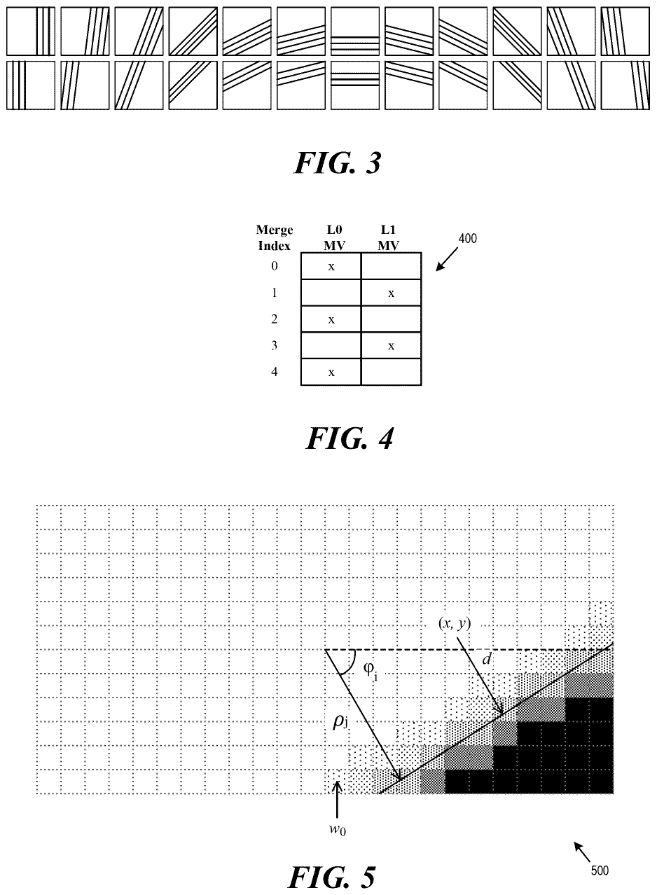

FIG. 3 illustrates the partitioning of a CU by the geometric partitioning mode (GPM). The FIGURE illustrates examples of the GPM splits grouped by identical angles. As illustrated, when GPM is used, a CU is split into at least two parts by a geometrically located straight line. The location of the splitting line is mathematically derived from the angle and offset parameters of a specific partition.

Each partition in the CU formed by a partition mode of GPM is inter-predicted using its own motion (vector). In some embodiments, only uni-prediction is allowed for each partition, that is, each part has one motion vector and one reference index. The uni-prediction motion constraint is applied to ensure that, similar to conventional bi-prediction, only two motion compensated prediction are performed for each CU.

If GPM is used for the current CU, then a geometric partition index indicating the partition mode of the geometric partitioning (angle and offset) and two merge indices (one for each partition) are further signalled. Each of the at least two partitions created by the geometric partitioning according to a partition mode may be assigned a merge index to select a candidate from a uni-prediction candidate list (also referred to as the GPM candidate list). The pair of merge indices of the two partitions therefore select a pair of merge candidates. The maximum number of candidates in the GPM candidate list may be signalled explicitly in SPS to specify syntax binarization for GPM merge indices. After predicting each of the at least two partitions, the sample values along the geometric partitioning edge are adjusted using a blending processing with adaptive weights. This is the prediction signal for the whole CU, and transform and quantization process will be applied to the whole CU as in other prediction modes. The motion field of the CU as predicted by GPM is then stored.

The uni-prediction candidate list for a GPM partition (the GPM candidate list) may be derived directly from the merge candidate list of the current CU. FIG. 4 illustrates an example uni-prediction candidate list 400 for a GPM partition and the selection of a uni-prediction MV for GPM. The GPM candidate list 400 is constructed in an even-odd manner with only uni-prediction candidates that alternates between L0 MV and L1 MV. Let n be the index of the uni-prediction motion in the uni-prediction candidate list for GPM. The LX (i.e., L0 or L1) motion vector of the n-th extended merge candidate, with X equal to the parity of n, is used as the n-th uni-prediction motion vector for GPM. (These motion vectors are marked with “x” in the FIGURE.) In case a corresponding LX motion vector of the n-th extended merge candidate does not exist, the L(1−X) motion vector of the same candidate is used instead as the uni-prediction motion vector for GPM.

As mentioned, the sample values along the geometric partition edge are adjusted using a blending processing with adaptive weights. Specifically, after predicting each part of a geometric partition using its own motion, blending is applied to the at least two prediction signals to derive samples around geometric partition edge. The blending weight for each position of the CU are derived based on the distance between the individual position and the partition edge. The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j}$$

$${ρ}_{j} = {ρ}_{x , j} cos ( {φ}_{i} ) + {ρ}_{y , j} sin ( {φ}_{i} )$$

$${ρ}_{x , j} = \{ \begin{matrix}0 & i \% 16 = 8 or ( i \% 16 \neq 0 and h \geq w ) \\ \pm ( j \times w ) >> 2 & otherwise\end{matrix}$$

$${ρ}_{y , j} = \{ \begin{matrix}\pm ( j \times h ) >> 2 & i \% 16 = 8 or ( i \% 16 \neq 0 and h \geq w ) \\ 0 & otherwise\end{matrix}$$

where i, j are the indices for angle and offset of a geometric partition, which depend on the signaled geometric partition index. The sign of ρ_{x,j} and ρ_{y,j} depend on angle index i. The weights for each part of a geometric partition are derived as following:

$$wIdxL ( x , y ) = partIdx ? 32 + d ( x , y ) : 32 - d ( x , y )$$

$${w}_{0} ( x , y ) = \frac{Clip 3 ( 0 , 8 , ( wIdx L ( x , y ) + 4 ) >> 3 )}{8}$$

$${w}_{1} ( x , y ) = 1 - {w}_{0} ( x , y )$$

The variable partIdx depends on the angle index i. FIG. 5 illustrates an example partition edge blending process for GPM for a CU 500. In the FIGURE, blending weights are generated based on an initial blending weight w₀.

As mentioned, the motion field of a CU predicted using GPM is stored. Specifically, Mv1 from the first part of the geometric partition, Mv2 from the second part of the geometric partition and a combined Mv of Mv1 and Mv2 are stored in the motion field of the GPM coded CU. The stored motion vector type for each individual position in the motion filed are determined as:

sType=abs(motionIdx)<32?2:(motionIdx≤0?(1−partIdx):partIdx)
where motionIdx is equal to d (4x+2, 4y+2), which is recalculated from equation (2). The partIdx depends on the angle index i. If sType is equal to 0 or 1, Mv0 or Mv1 are stored in the corresponding motion field, otherwise if sType is equal to 2, a combined Mv from Mv0 and Mv2 are stored. The combined Mv are generated using the following process: (i) If Mv1 and Mv2 are from different reference picture lists (one from L0 and the other from L1), then Mv1 and Mv2 are simply combined to form the bi-prediction motion vectors; (ii) otherwise, if Mv1 and Mv2 are from the same list, only uni-prediction motion Mv2 is stored.
   e. Template Matching (TM)

Template matching (TM) is a decoder-side MV derivation method to refine the motion information of the current CU by finding the closest match between a template of the current CU (e.g., top and/or left neighbouring blocks of the current CU) in the current picture and a set of pixels (i.e., same size to the template) in a reference picture.

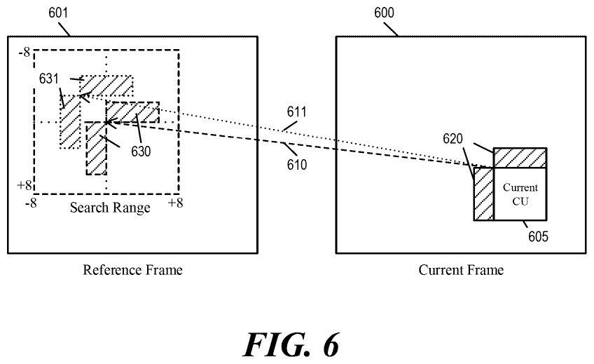

FIG. 6 conceptually illustrates performing template matching based on a search area around an initial motion vector (MV). As illustrated, for a current CU 605 in a current picture 600, the video coder searches the reference picture or frame 601 within a [−8, +8]-pel search range around an initial MV 610 for a better or refined MV 611. The initial MV 610 identifies an initial reference template 630. The refined MV 611 identifies a refined reference template 631. The search is based on minimizing the difference (or cost) between a current template 620 neighboring the current block 605 and the refined reference template 631. The template matching may be performed with a search step size that is determined based on an adaptive motion vector resolution mode (AMVR). The template matching process can be cascaded with a bilateral matching process in merge modes.

In advanced motion vector prediction (AMVP) mode, an MVP candidate is determined based on template matching error to select the one that reaches the minimum difference between the current block template and the reference block template, and then TM is performed only for this particular MVP candidate for MV refinement. The TM process refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on a AMVR mode search pattern.

Adaptive Reordering of Merge Candidates with Template Matching (ARMC-TM) is a method to re-order merge candidates based on template-matching (TM) cost, where signaling efficiency is improved by sorting merge candidates in ascending order of TM costs. For the ARMC-TM, or TM merge mode, merge candidates are reordered before the refinement process. The template matching cost of a merge candidate may be measured by the sum of absolute differences (SAD) between samples of the current template 620 of the current block and their corresponding reference samples in the reference template 621.

In some embodiments, after a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. In some embodiments, merge candidates in the last but not the first subgroup are not reordered.

For subblock-based merge candidates with subblock size equal to Wsub×Hsub, the above template may include several sub-templates with the size of Wsub×1, and the left template includes several sub-templates with the size of 1×Hsub. In some embodiments, the motion information of the subblocks in the first row and the first column of current block is used to derive the reference samples of each sub-template.

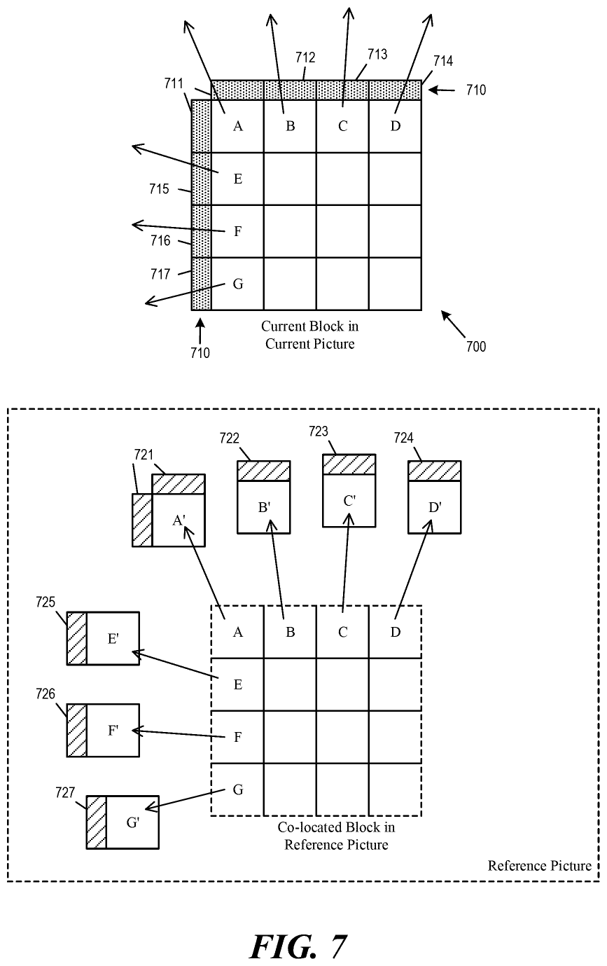

FIG. 7 conceptually illustrates a current block 700 having sub-block motion. The current block 700 is coded by using the motion information of the subblocks in the first row and the first column (subblocks A-G) of the current block. The motion information of subblocks A-G are used to identify reference subblocks A′-G′ in a reference picture. The current block 700 has a neighboring template 710, which includes sub-templates 711-717 that neighbors subblocks A-G, respectively, that are above and left of the current block 700. The reference subblocks A′-G′ has corresponding neighboring reference sub-templates 721-727 in the reference picture. The TM costs of the motion information of the different subblocks can be computed by matching the sub-templates 711-717 with the corresponding respective sub-templates 721-727.

f. Decoder Motion Vector Refinement (DMVR)

In order to increase the accuracy of the MVs of the merge mode, a bilateral-matching (BM) based decoder side motion vector refinement can be applied to refine MVs. In bi-prediction operation, a refined MV is searched around the initial MVs in the reference picture list L0 and reference picture list L1. The BM method calculates the distortion between the two candidate blocks in the reference picture list L0 and list L1. The MV candidate with the lowest SAD becomes the refined MV and used to generate the bi-predicted signal.

In some embodiments, a multi-pass decoder-side motion vector refinement (MP-DMVR) method is applied in regular merge mode if the selected merge candidate meets the DMVR conditions. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The BM refines a pair of motion vectors MV0 and MV1 under the constraint that motion vector difference MVD0 (i.e., MV0′-MV0) is just the opposite sign of motion vector difference MVD1 (i.e., MV1′-MV1).

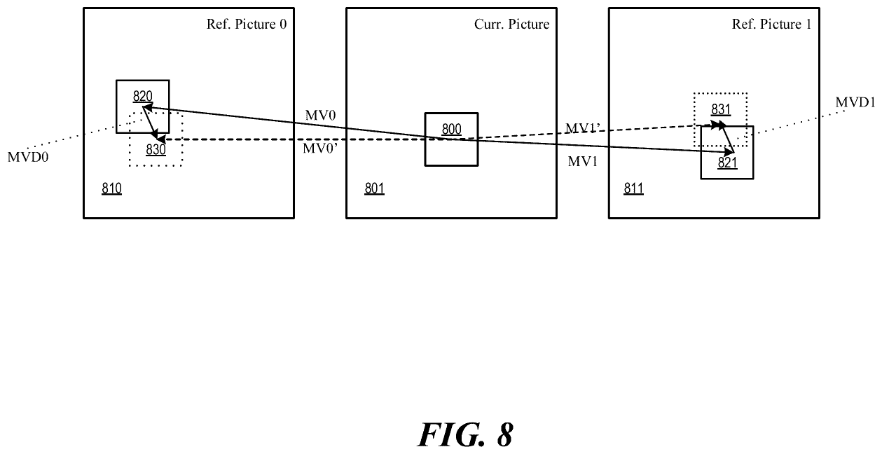

FIG. 8 conceptually illustrates refinement of a prediction candidate (e.g., merge candidate) by bilateral matching (BM). MV0 is an initial motion vector or a prediction candidate, MV1 is the mirror of MV0. MV0 references an initial reference block 820 in reference picture 810. MV1 references an initial reference block 821 in a reference picture 811. The FIGURE shows MV0 and MV1 being refined to form MV0′ and MV1′, which updated reference blocks 830 and 831, respectively. The refinement is performed according to bilateral matching, such that the refined motion vector pair MV0′ and MV1′ has better bilateral matching cost than the initial motion vector pair MV0 and MV1. MV0′-MV0 (i.e., MVD0) and MV1′-MV1 (i.e., MVD1) are constrained to be equal in magnitude but opposite in direction. In some embodiments, the bilateral matching cost of a pair of mirrored motion vectors (e.g., MV0 and MV1) is calculated based on the difference between the two reference blocks referred by the mirrored motion vectors (e.g., difference between the reference blocks 820 and 821).

g. Intra Prediction

Intra-prediction method exploits one reference tier adjacent to the current prediction unit (PU) and one of the intra-prediction modes to generate the predictors for the current PU. The Intra-prediction direction can be chosen among a mode set containing multiple prediction directions. For each PU coded by Intra-prediction, one index will be used and encoded to select one of the intra-prediction modes. The corresponding prediction will be generated and then the residuals can be derived and transformed.

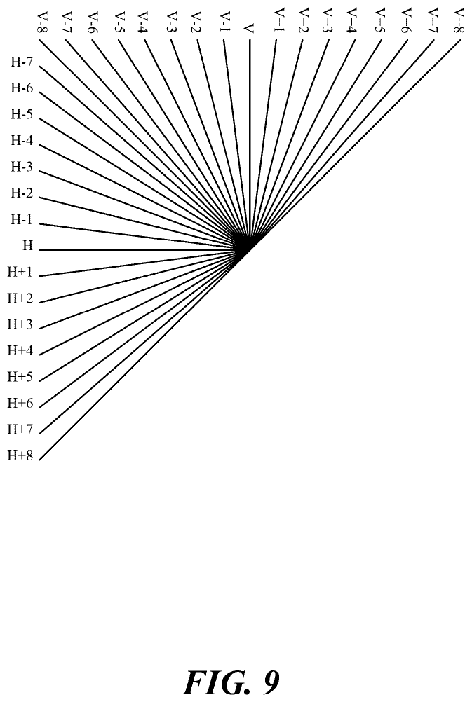

FIG. 9 shows the intra-prediction modes in different directions. These intra-prediction modes are referred to as directional modes and do not include DC mode or Planar mode. As illustrated, there are 33 directional modes (V: vertical direction; H: horizontal direction), so H, H+1~H+8, H−1~H−7, V, V+1~V+8, V−1~V−8 are used. Generally directional modes can be represented as either as H+k or V+k modes, where k=±1, ±2, . . . , ±8. Each of such intra-prediction mode can also be referred to as an intra-prediction angle. To capture arbitrary edge directions presented in natural video, the number of directional intra modes may be extended from 33, as used in HEVC, to 65 direction modes so that the range of k is from ±1 to ±16. These denser directional intra prediction modes apply for all block sizes and for both luma and chroma intra predictions. By including DC and Planar modes, the number of intra-prediction mode is 35 (or 67).

Out of the 35 (or 67) intra-prediction modes, some modes (e.g., 3 or 5) are identified as a set of most probable modes (MPM) for intra-prediction in current prediction block. The encoder may reduce bit rate by signaling an index to select one of the MPMs instead of an index to select one of the 35 (or 67) intra-prediction modes. For example, the intra-prediction mode used in the left prediction block and the intra-prediction mode used in the above prediction block are used as MPMs. When the intra-prediction modes in two neighboring blocks use the same intra-prediction mode, the intra-prediction mode can be used as an MPM. When only one of the two neighboring blocks is available and coded in directional mode, the two neighboring directions immediately next to this directional mode can be used as MPMs. DC mode and Planar mode are also considered as MPMs to fill the available spots in the MPM set, especially if the above or top neighboring blocks are not available or not coded in intra-prediction, or if the intra-prediction modes in neighboring blocks are not directional modes. If the intra-prediction mode for current prediction block is one of the modes in the MPM set, 1 or 2 bits are used to signal which one it is. Otherwise, the intra-prediction mode of the current block is not the same as any entry in the MPM set, and the current block will be coded as a non-MPM mode. There are all-together 32 such non-MPM modes and a (5-bit) fixed length coding method is applied to signal this mode.

The MPM list is constructed based on intra modes of the left and above neighboring block. Suppose the mode of the left neighboring block is denoted as Left and the mode of the above neighboring block is denoted as Above, and the unified MPM list may be constructed as follows:
When a neighboring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max-Min is equal to 1:
      MPM list→{Planar, Left, Above, Min−1, Max+1, Min−2}
   Otherwise, if Max-Min is greater than or equal to 62:
      MPM list→{Planar, Left, Above, Min+1, Max−1, Min+2}
   Otherwise, if Max-Min is equal to 2:
      MPM list→{Planar, Left, Above, Min+1, Min−1, Max+1}
   Otherwise:
      MPM list→{Planar, Left, Above, Min−1, Min+1, Max−1}
If Left and Above are both angular and they are the same:
   MPM list→{Planar, Left, Left−1, Left+1, Left−2, Left+2}

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indices, which are remapped to indices of wide angular modes after parsing.

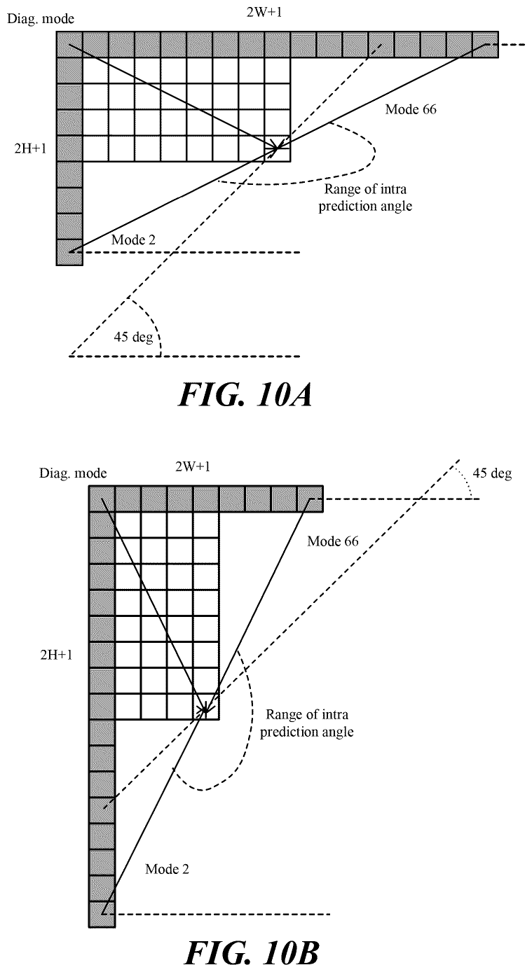

For some embodiments, the total number of intra prediction modes is unchanged, i.e., 67, and the intra mode coding method is unchanged. To support these prediction directions, a top reference template with length 2 W+1 and a left reference template with length 2H+1 are defined. FIGS. 10A-B conceptually illustrate top and left reference templates with extended lengths for supporting wide-angular direction mode for non-square blocks of different aspect ratios.

h. Overlapped Block Motion Compensation (OBMC)

Overlapped block motion compensation (OBMC) is a video coding tool that reduces blocking artifact by refining top and left boundary pixels of a CU by using neighboring block's motion information with a weighted prediction, specifically:

Inter′_{predY}=((128−w₁)×Inter_{predY}+w₁×OBMC_{predY})/128

PredY=((4−w₀)×FwdMap(Inter′_{predY})+w₀×Intra_{predY})/4

where Inter_{predY} represents the samples predicted by the motion of current block in the original domain, Intra_{predY} represents the samples predicted in the mapped domain, OBMC_{predY} represents the samples predicted by the motion of neighboring blocks in the original domain, and w₀ and w₁ are the weights.

A subblock-boundary OBMC is performed by applying the same blending to the top, left, bottom, and right subblock boundary pixels using neighboring subblocks' motion information. OBMC may be enabled for the subblock based coding tools such as Affine AMVP modes, Affine merge modes and subblock-based temporal motion vector prediction, and subblock-based bilateral matching. When OBMC mode is used in CIIP mode with luma mapping with chroma scaling (LMCS), inter blending is performed prior to LMCS mapping of inter samples. LMCS is applied to blended inter samples which are combined with LMCS applied intra samples in CIIP mode.

### III. Out-Of-Boundary Check for Prediction Coding Tools

To improve coding efficiency of bi-directional motion compensation with OOB check, some embodiments of the disclosure provide a method for performing OOB check to predictive coding modes other than bi-directional motion compensation.

### A.OOB Check for ERP Video

In some embodiments, for horizontal wrap around motion compensation process or for motion compensation of 360-degree video in the equi-rectangular projection (ERP) format, bi-directional motion compensation with OOB check is only applied to vertical direction, that is, use horizontal wrap around motion compensation for OOB samples at horizontal direction and use bi-directional motion compensation with OOB check for OOB samples at vertical direction. In some embodiments, for horizontal wrap around motion compensation process or for motion compensation of 360-degree video in the ERP projection format, bi-directional motion compensation with OOB check is not applied.

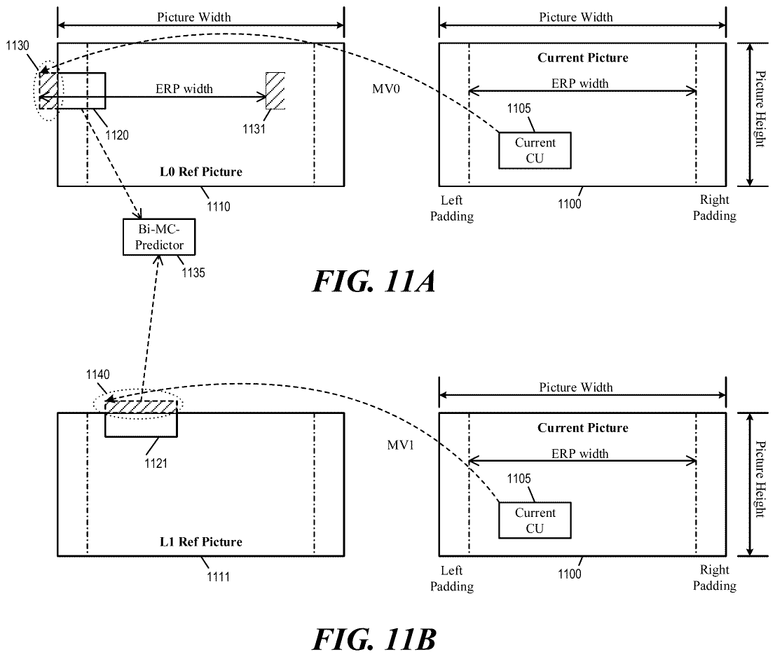

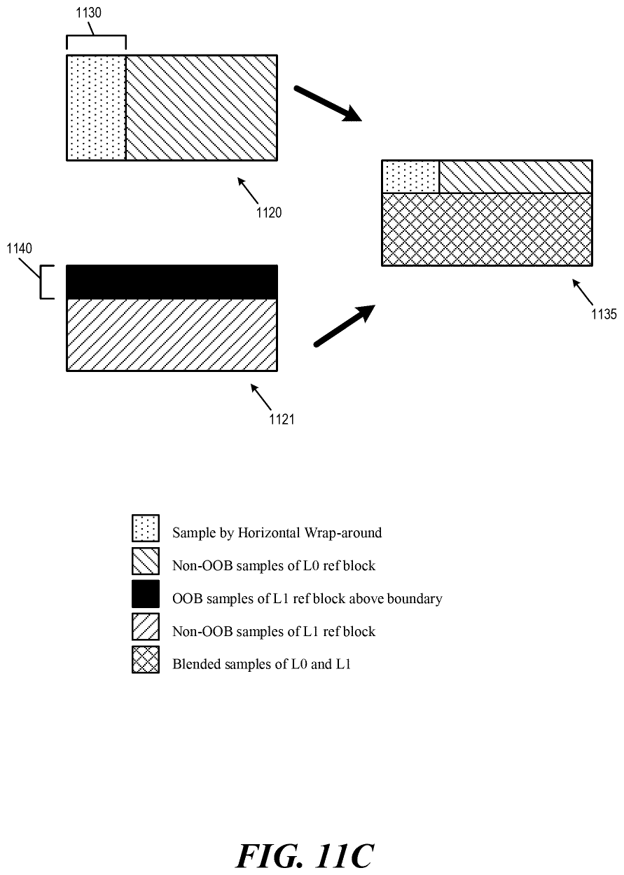

FIGS. 11A-C conceptually illustrate horizontal wrap-around motion compensation with out-of-boundary (OOB) checks. A current block 1105 in a current picture 1100 is coded by bi-prediction using motion vectors MV0 and MV1. FIG. 11A shows MV0 pointing to a reference block 1120 in a reference picture 1110. FIG. 11B shows MV1 pointing to a reference block 1121 in a L1 reference picture 1111.

As illustrated, a part 1130 of the reference block 1120 is OOB by being outside of the left (or right) boundary of the projected domain of the reference picture 1110. Instead of repetitive padding, the samples for the OOB part 1130 of the reference block 1120 are generated by horizontal wrap-around motion compensation, specifically by replicating from a spherical neighbor part 1131 that is located within the reference picture 1110 toward the right boundary in the projected domain. A part 1140 of the reference block 1121 is OOB by being outside of the top (or bottom) boundary of the projected domain of the L1 reference picture 1111. In some embodiments, repetitive padding is applied to generate the samples of the OOB part 1140.

FIG. 11C illustrates generating a bi-directional motion compensation predictor 1135 based on the OOB and the non-OOB samples for ERP video. For some embodiments, the methods described in Section I above can be used to generate the predictor 1135 for the current block 1110 based on the reference blocks 1120 and 1121 and their respective OOB status. For some embodiments, the samples generated by horizontal wrap-around for the OOB part 1130 of the reference block 1120 are not considered OOB samples.

As illustrated, at positions that do not correspond to OOB samples, the non-OOB samples from the reference block 1120 (including horizontal wrap-around samples 1130) and the non-OOB samples from the reference block 1121 are blended (by e.g., weighted averaging) to generate prediction samples for the predictor 1135. On the other hand, at sample positions that correspond to the OOB samples (e.g., positions in OOB part 1140), the non-OOB samples from the reference block 1120 (including horizontal wrap-around samples 1130) are used (so OOB samples are not included in the predictor 1135).

### B.OOB Check for Intra-Predicted Blocks

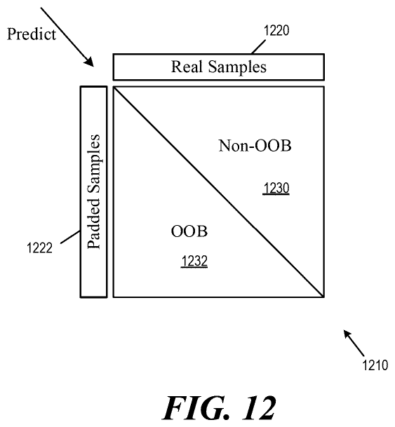

In some embodiments, OOB check is applied to intra-predicted blocks. In some embodiments, if a sample is generated by padded L-neighbor (for example, at picture boundary) in an intra block, the video coder may treat the sample as OOB. FIG. 12 conceptually illustrates intra prediction with OOB reference samples. As illustrated, a current block 1210 is intra-predicted. The samples of an upper/top L-neighbor 1220 of the current block are real reconstructed samples, and the samples of a left L-neighbor 1222 of the current block are padding samples. The block 1210 is intra predicted by a diagonal direction. The samples in an upper triangle 1230 are non-OOB and the samples in a lower triangle 1232 are OOB samples.

### C.OOB for Blocks with Decoder-Side MV Refinement

In some embodiments, OOB check is applied to a DMVR sub-block (or coding block level MP-DMVR, or subblock level MP-DMVR). Specifically, if a search point (e.g., the initial MV and the MV offset) in L0 and/or L1 reference picture is OOB, the search point is designated as unavailable or deprioritized relative to non-OOB search points (by e.g., applying additional costs or a pre-defined large cost.) In some embodiment, if all search points and the initial MV are OOB, then the refined MV is set to initial MV.

In some embodiments, even if the initial MV is OOB, the video coder still compares the initial MV with other non-OOB search points. The video coder does not set the initial MV as unavailable, or set the initial MV to a lower priority than non-OOB search points, or add additional costs, or apply a pre-defined large cost.

### D.OOB for Sub-Blocks in Reference Pictures

In some embodiments, when bi-prediction uses sub-blocks in L0 and/or L1 reference pictures, a sub-block in the L0 or L1 reference picture is OOB if a sample in the sub-block is OOB. In some embodiments, if the number of OOB samples in the sub-block is larger than a pre-defined threshold, or if the ratio of OOB samples in the sub-block is larger than a pre-defined ratio, or if all samples in the sub-block are OOB, then the sub-block is OOB. In some embodiments, a search point is OOB if both sub-blocks in L0 and L1 reference pictures are OOB, or any one of the sub-blocks in L0 or L1 reference picture is OOB.

### E.OOB for GPM Coded Blocks

In some embodiments, OOB check is applied to the two (or more) partitions of a GPM coded block (by e.g., GPM-TM, GPM-MMVD, GPM-INTER-INTRA, GPM-INTRA-INTRA.) Specifically, OOB checks may be performed for two Inter partitions, or one Inter partition and one Intra partition, or two Intra partitions. GPM blending is then applied to the results of OOB checks according to the following:
If P_{i,j}^{part0} is OOB and P_{i,j}^{part1} is non-OOB, then P_{i,j}^{final}=P_{i,j}^{final}=P_{i,j}^{part0}
else if P_{i,j}^{part0} is non-OOB and P_{i,j}^{part1} is OOB, then P_{i,j}^{final}=P_{i,j}^{part0}
else P_{i,j}^{final}=GPM_blending (P_{i,j}^{part0}, P_{i,j}^{part1})

In some embodiments, the OOB check is not applied to Intra part and is only applied to Inter part, such that the OOB check results of the Intra part is always non-OOB. GPM Blending for GPM with one Inter part and one Intra part may be computed according to the following:
If P_{i,j}^{partX} is OOB and partX is Inter and part 1−X is Intra, then P_{i,j}^{final}=P_{i,j}^{part(1-X)}
else P_{i,j}^{final}=GPM_blending (P_{i,j}^{part0}, P_{i,j}^{part1})

If a sample of the Inter part is OOB, the samples of Intra part is used as predictor. Otherwise, blending is applied to the samples of the two parts. GPM Blending for GPM with two Intra parts is the same as GPM blending for GPM with two Inter parts. In some embodiments, if the inter prediction signal of Inter part is bi-prediction, the OOB check results may be derived from OOB results of the L0 reference and OOB results of L1 reference:
If Inter Part is Bi-Prediction,
   OOB of P_{i,j}^{Inter}=OOB of P_{i,j}^{Inter,L0} & OOB of P_{i,j}^{Inter,L1}
Or if Inter Part is Bi-Prediction (Alternative Method):
   OOB of P_{i,j}^{Inter}=OOB of P_{i,j}^{Inter,L0}|OOB of P_{i,j}^{Inter,L1}

### F. OOB for CIIP Coded Blocks

In some embodiments, OOB check is applied to Inter part and Intra part of CIIP, then apply CIIP blending with results of OOB checks according to the following:
If Inter part is uni-prediction (L0):
   OOB of P_{i,j}^{Inter}=OOB of P_{i,j}^{Inter,L0}
If Inter part is uni-prediction (L1):
   OOB of P_{i,j}^{Inter}=OOB of P_{i,j}^{Inter,L1}
If inter part is bi-prediction:
   OOB of P_{i,j}^{Inter}=OOB of P_{i,j}^{Inter,L0}& OOB of P_{i,j}^{Inter,L1}
Or if Inter part is bi-prediction (alternative method):
   OOB of P_{i,j}^{Inter}=OOB of P_{i,j}^{Inter,L0}|OOB of P_{i,j}^{Inter,L1}
Then:
   If P_{i,j}^{Inter} is OOB and P_{i,j}^{Intra} is non-OOB
   P_{i,j}^{final}=P_{i,j}^{Intra}
else if P_{i,j}^{Inter} is non-OOB and P_{i,j}^{Intra} is OOB
   P_{i,j}^{final}=P_{i,j}^{Inter}
else
   P_{i,j}^{final}=CIIP_blending (P_{i,j}^{Inter}, P_{i,j}^{Intra})

In some embodiments, OOB check is not applied to Intra part and is only applied to Inter part, that is OOB check results of Intra part is always non-OOB. Then CHIP blending for CIIP with one Inter part and one Intra part is according to the following:
If P_{i,j}^{Inter} is OOB
   P_{i,j}^{final}=P_{i,j}^{Intra}
else
   P_{i,j}^{final}=CIIP_blending (P_{i,j}^{Inter}, P_{i,j}^{Intra})

If a sample of Inter part is OOB, use the corresponding sample of Intra part as predictor, otherwise apply CIIP blending to the samples of the two CIIP parts.

### G. OOB for Template Matching

In some embodiments, OOB check is applied to the template regions of template matching (TM) or ARMC-TM, then apply blending with results of OOB checks. For example, the video coder may perform motion vector refinement based on minimizing TM matching cost between a reference template (e.g., reference template 630) neighboring the reference block and a current template (e.g., current template 620) neighboring the current block. The TM cost may be calculated based on OOB checks of the reference template and/or the current template. For example, OOB samples in the reference template will not be used for determining the TM cost.

### H. OOB for OBMC

In some embodiments, OOB check is applied to overlapped block motion compensation (OBMC), then blending additional inter prediction with results of OOB checks. If the OBMC inter prediction signal is OOB, the OBMC inter prediction signal is not blended with the original prediction signal. Otherwise, if the OBMC inter prediction signal is not OOB, the OBMC inter prediction signal is blended with the original prediction signal. In some embodiments, if the additional inter prediction signal is bi-prediction, the OOB check results may be derived from OOB results of L0 prediction (or reference block) and OOB results of L1 prediction (or reference block) according to the following:
If Inter part is bi-prediction:
   OOB of P_{i,j}^{Inter}=OOB of P_{i,j}^{Inter,L0}& OOB of P_{i,j}^{Inter,L1}
Or if Inter part is bi-prediction (alternative method):
   OOB of P_{i,j}^{Inter}=OOB of P_{i,j}^{Inter,L0}|OOB of P_{i,j}^{Inter,L1}

### J. OOB for MHP

In some embodiments, the video coder applies OOB check to Multi-Hypothesis Prediction (MHP), then adds additional inter prediction signal/hypothesis with results of OOB checks. If the additional inter prediction signal is OOB, the additional inter prediction signal is not added to the original prediction signal. Otherwise, if the additional inter prediction signal is not OOB, the additional inter prediction signal is added to the original prediction signal. In some embodiments, if the additional inter prediction signal is bi-prediction, the OOB check results may be derived from OOB results of L0 prediction (reference block) and OOB results of L1 prediction (reference block) according to the following:
If Inter part is bi-prediction:
   OOB of P_{i,j}^{Inter}=OOB of P_{i,j}^{Inter,L0}& OOB of P_{i,j}^{Inter,L1}
Or if Inter part is bi-prediction (alternative method):
   OOB of P_{i,j}^{Inter}=OOB of P_{i,j}^{Inter,L0}|OOB of P_{i,j}^{Inter,L1}

The foregoing proposed method can be implemented in encoders and/or decoders. For example, the proposed method can be implemented in a inter prediction module and/or intra block copy prediction module of an encoder, and/or a inter prediction module (and/or intra block copy prediction module) of a decoder.

### IV. Example Video Encoder

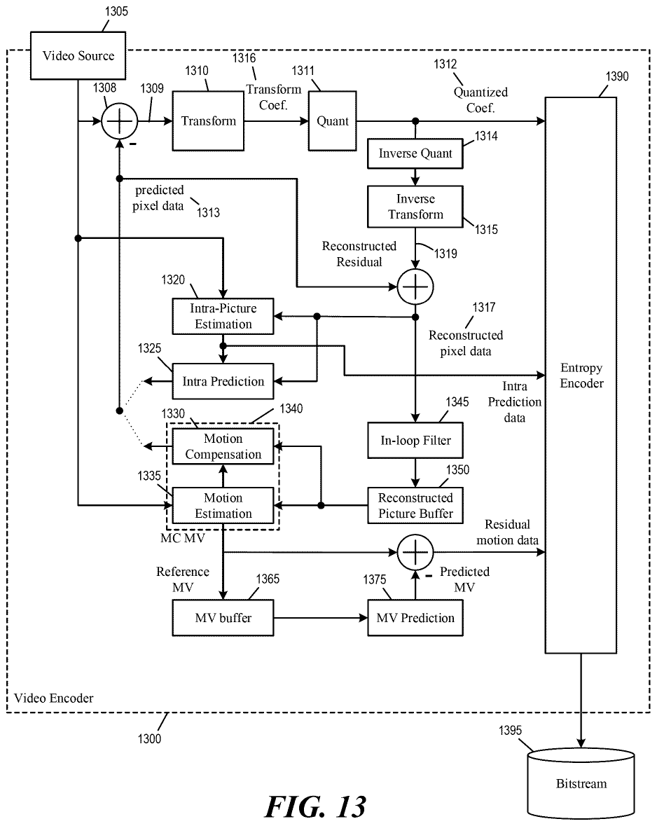

FIG. 13 illustrates an example video encoder 1300 that may implement predictive coding. As illustrated, the video encoder 1300 receives input video signal from a video source 1305 and encodes the signal into bitstream 1395. The video encoder 1300 has several components or modules for encoding the signal from the video source 1305, at least including some components selected from a transform module 1310, a quantization module 1311, an inverse quantization module 1314, an inverse transform module 1315, an intra-picture estimation module 1320, an intra-prediction module 1325, a motion compensation module 1330, a motion estimation module 1335, an in-loop filter 1345, a reconstructed picture buffer 1350, a MV buffer 1365, and a MV prediction module 1375, and an entropy encoder 1390. The motion compensation module 1330 and the motion estimation module 1335 are part of an inter-prediction module 1340.

In some embodiments, the modules 1310-1390 are modules of software instructions being executed by one or more processing units (e.g., a processor) of a computing device or electronic apparatus. In some embodiments, the modules 1310-1390 are modules of hardware circuits implemented by one or more integrated circuits (ICs) of an electronic apparatus. Though the modules 1310-1390 are illustrated as being separate modules, some of the modules can be combined into a single module.

The video source 1305 provides a raw video signal that presents pixel data of each video frame without compression. A subtractor 1308 computes the difference between the raw video pixel data of the video source 1305 and the predicted pixel data 1313 from the motion compensation module 1330 or intra-prediction module 1325 as prediction residual 1309. The transform module 1310 converts the difference (or the residual pixel data or residual signal 1308) into transform coefficients (e.g., by performing Discrete Cosine Transform, or DCT). The quantization module 1311 quantizes the transform coefficients into quantized data (or quantized coefficients) 1312, which is encoded into the bitstream 1395 by the entropy encoder 1390.

The inverse quantization module 1314 de-quantizes the quantized data (or quantized coefficients) 1312 to obtain transform coefficients, and the inverse transform module 1315 performs inverse transform on the transform coefficients to produce reconstructed residual 1319. The reconstructed residual 1319 is added with the predicted pixel data 1313 to produce reconstructed pixel data 1317. In some embodiments, the reconstructed pixel data 1317 is temporarily stored in a line buffer (not illustrated) for intra-picture prediction and spatial MV prediction. The reconstructed pixels are filtered by the in-loop filter 1345 and stored in the reconstructed picture buffer 1350. In some embodiments, the reconstructed picture buffer 1350 is a storage external to the video encoder 1300. In some embodiments, the reconstructed picture buffer 1350 is a storage internal to the video encoder 1300.

The intra-picture estimation module 1320 performs intra-prediction based on the reconstructed pixel data 1317 to produce intra prediction data. The intra-prediction data is provided to the entropy encoder 1390 to be encoded into bitstream 1395. The intra-prediction data is also used by the intra-prediction module 1325 to produce the predicted pixel data 1313.

The motion estimation module 1335 performs inter-prediction by producing MVs to reference pixel data of previously decoded frames stored in the reconstructed picture buffer 1350. These MVs are provided to the motion compensation module 1330 to produce predicted pixel data.

Instead of encoding the complete actual MVs in the bitstream, the video encoder 1300 uses MV prediction to generate predicted MVs, and the difference between the MVs used for motion compensation and the predicted MVs is encoded as residual motion data and stored in the bitstream 1395.

The MV prediction module 1375 generates the predicted MVs based on reference MVs that were generated for encoding previously video frames, i.e., the motion compensation MVs that were used to perform motion compensation. The MV prediction module 1375 retrieves reference MVs from previous video frames from the MV buffer 1365. The video encoder 1300 stores the MVs generated for the current video frame in the MV buffer 1365 as reference MVs for generating predicted MVs.

The MV prediction module 1375 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1395 by the entropy encoder 1390.

The entropy encoder 1390 encodes various parameters and data into the bitstream 1395 by using entropy-coding techniques such as context-adaptive binary arithmetic coding (CABAC) or Huffman encoding. The entropy encoder 1390 encodes various header elements, flags, along with the quantized transform coefficients 1312, and the residual motion data as syntax elements into the bitstream 1395. The bitstream 1395 is in turn stored in a storage device or transmitted to a decoder over a communications medium such as a network.

The in-loop filter 1345 performs filtering or smoothing operations on the reconstructed pixel data 1317 to reduce the artifacts of coding, particularly at boundaries of pixel blocks. In some embodiments, the filtering or smoothing operations performed by the in-loop filter 1345 include deblock filter (DBF), sample adaptive offset (SAO), and/or adaptive loop filter (ALF).

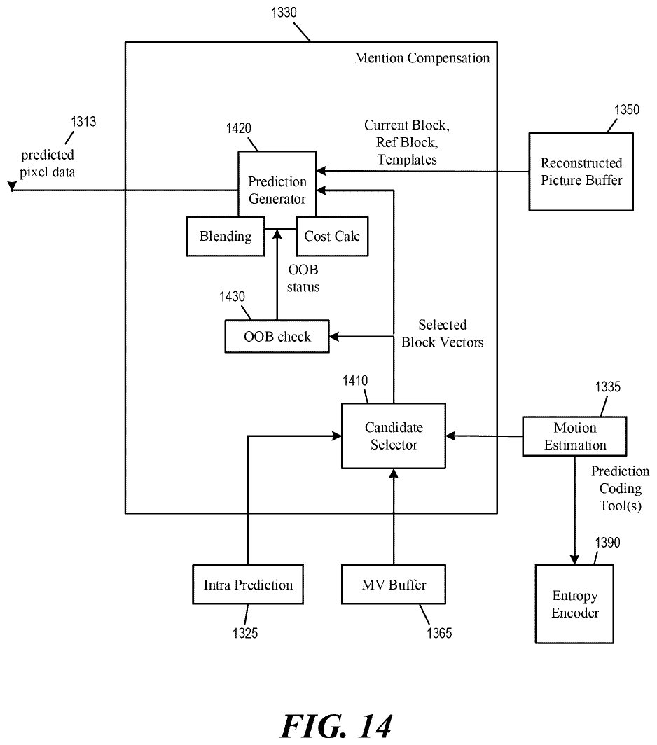

FIG. 14 illustrates portions of the video encoder 1300 that implement out-of-bound checks for predictive coding. Specifically, the FIGURE illustrates the components of the motion compensation module 1330 of the video encoder 1300.

As illustrated, the motion compensation module 1330 has a candidate selector 1410 that selects block vectors (including motion vectors and intra prediction modes) from the MV buffer 1365 and the intra prediction module 1325. The selection is controlled by the motion estimation module 1335. The selected block vectors are examined by a OOB check module 1430, which determines whether the reference blocks identified by the block vectors are out-of-bound. The selected block vectors are also provided to a prediction generator module 1420.

The prediction generator module 1420 generates a predictor or prediction block for the current block as the predicted pixel data 1313 by fetching samples from the reconstructed picture buffer 1350. The motion estimation module 1335 selects one or more prediction coding tools for the current block (e.g., bi-prediction, GPM, CIIP, MHP, intra-prediction, IBC, etc.), and the prediction generator module 1420 generates the predictor based on the selected prediction tool(s). The motion estimation module 1335 also provides the prediction tool selection to the entropy encoder 1390 to be signaled in the bitstream 1395.

The predictor generator module 1420 also uses the OOB check result from the OOB check module 1430 to determine whether to exclude certain reference samples identified by the selected block vector(s) when performing blending to generate the predictor. For example, if the current picture is an ERP picture and the reference block identified by the block vector has OOB samples, the predictor generator module 1420 may use the horizontal wrap-around samples fetched from the reconstructed picture buffer 1650 for blending if the reference block is OOB at the left or right boundary, or exclude the OOB samples from blending if the reference block is OOB at the top or bottom boundary. The predictor generator module 1420 may also use the OOB result to determine whether to exclude samples from BM cost calculation or TM cost calculation.

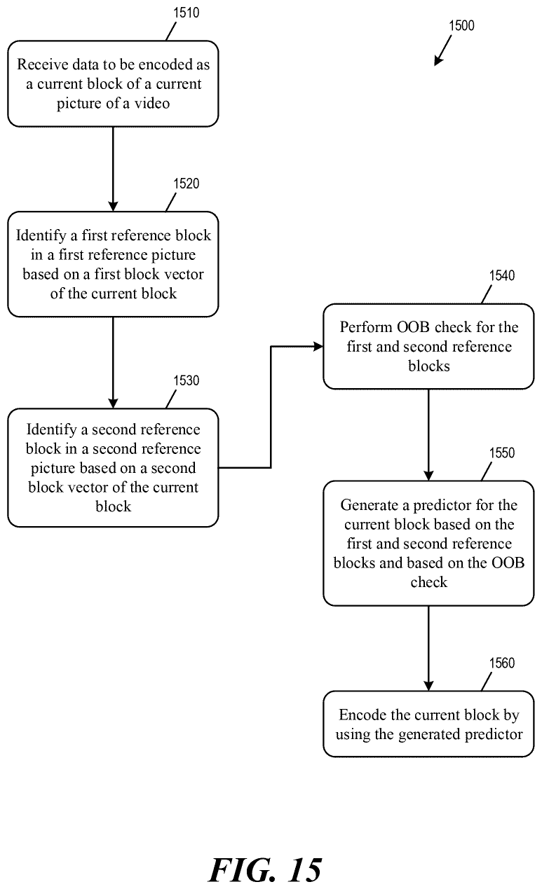

FIG. 15 conceptually illustrates a process 1500 for using out-of-bound checks for predictive coding of a block of pixels. In some embodiments, one or more processing units (e.g., a processor) of a computing device implementing the encoder 1300 performs the process 1500 by executing instructions stored in a computer readable medium. In some embodiments, an electronic apparatus implementing the encoder 1300 performs the process 1500.

The encoder receives (at block 1510) data to be encoded as a current block of pixels in a current picture of a video. The encoder identifies (at block 1520) a first reference block in a first reference picture based on a first block vector of the current block. The encoder identifies (at block 1530) a second reference block in a second reference picture based on a second block vector of the current block. The first and second block vectors may be motion vectors. In some embodiments, the first reference picture or the second reference picture is the current picture, and the first block vector or the second block vector is an intra-prediction direction or mode.

The encoder performs (at block 1540) out-of-bound (OOB) check for the first and second reference blocks. The encoder generates (at block 1550) a predictor for the current block based on the first and second reference blocks and based on the OOB check. In some embodiments, when a sample of the first reference block is OOB, a bi-directional motion compensation is not applied to at least one of a horizontal direction and a vertical direction. In some embodiments, when a sample of the first reference block is OOB over a left or right boundary of the first reference picture or when a sample of the first reference block is OOB over a top or bottom boundary of the first reference picture, the bi-directional motion compensation is not applied. In some embodiments, when a sample of the first reference block is a non-OOB sample, a corresponding predictor sample is generated by blending the non-OOB sample of the first reference block with a corresponding non-OOB sample of the second reference block. When a sample of the first reference block is a OOB sample, a corresponding predictor sample is generated by using a corresponding non-OOB sample of the second reference block without blending.

In some embodiments, the video may be a 360-degree video in an equi-rectangular projection (ERP) format. When a sample of the first reference block is OOB over a left or right boundary of the first reference picture, a corresponding predictor sample is generated by blending a horizontal wrap-around sample from the first reference picture with a corresponding non-OOB sample from the second reference block in the second reference picture. When a sample of the first reference block is OOB over a top or bottom boundary of the first reference picture, a corresponding predictor sample is generated by using a corresponding non-OOB sample from the second reference block without blending.

In some embodiments, the current block is partitioned into multiple geometric partitions, the first reference block is used to generate a first predictor for a first geometric partition and the second reference block is used to generate a second predictor for a second geometric partition. A corresponding predictor sample is generated by blending samples of the first and second predictors along a boundary between the first and second geometric partitions, with out-of-bound samples of the first and second predictors excluded from the blending.

In some embodiments, the generated predictor is a combined inter-intra prediction (CIIP), wherein the first reference block provides inter-prediction samples and the second reference block provide intra-prediction samples. In some embodiments, the current block is coded using MHP, such that the encoder performs an additional OOB check for a third reference block, and the predictor is generated further based on the third reference block and the additional OOB check.

In some embodiments, the first block vector is refined to minimize a calculated template matching cost between a reference template neighboring the first reference block and a current template neighboring the current block, with OOB samples of the reference template excluded from the cost calculation. In some embodiments, the first and second block vectors are refined to minimize a bilateral matching cost based on the first and second reference blocks, with OOB samples in the first and second reference blocks excluded from the cost calculation.

The encoder encodes (at block 1560) the current block by using the generated predictor to produce prediction residuals.

### V. Example Video Decoder

In some embodiments, an encoder may signal (or generate) one or more syntax element in a bitstream, such that a decoder may parse said one or more syntax element from the bitstream.

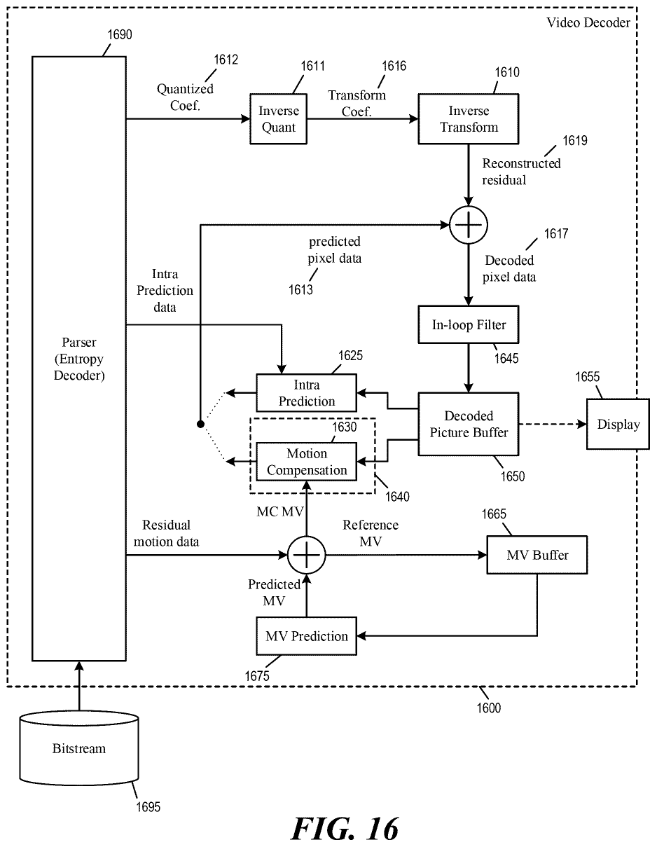

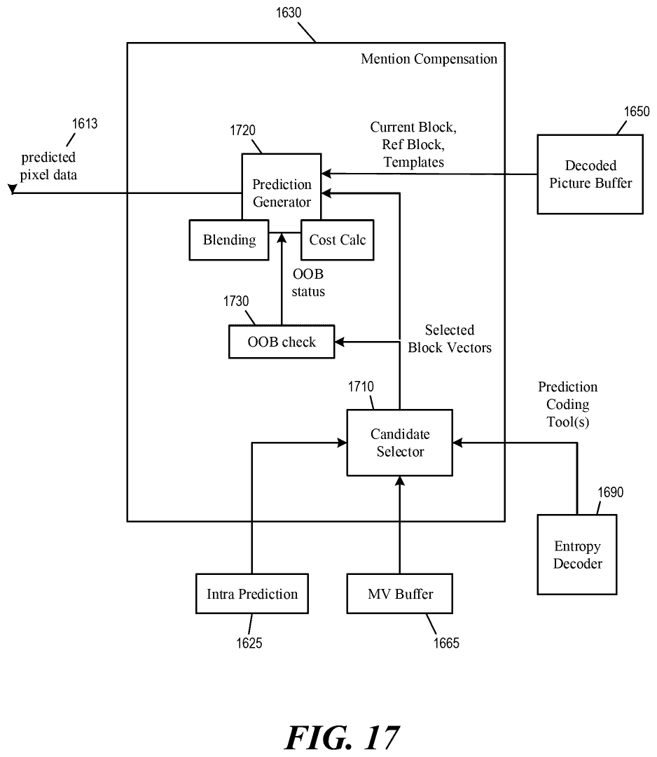

FIG. 16 illustrates an example video decoder 1600 that may implement predictive coding. As illustrated, the video decoder 1600 is an image-decoding or video-decoding circuit that receives a bitstream 1695 and decodes the content of the bitstream into pixel data of video frames for display. The video decoder 1600 has several components or modules for decoding the bitstream 1695, including some components selected from an inverse quantization module 1611, an inverse transform module 1610, an intra-prediction module 1625, a motion compensation module 1630, an in-loop filter 1645, a decoded picture buffer 1650, a MV buffer 1665, a MV prediction module 1675, and a parser 1690. The motion compensation module 1630 is part of an inter-prediction module 1640.

In some embodiments, the modules 1610-1690 are modules of software instructions being executed by one or more processing units (e.g., a processor) of a computing device. In some embodiments, the modules 1610-1690 are modules of hardware circuits implemented by one or more ICs of an electronic apparatus. Though the modules 1610-1690 are illustrated as being separate modules, some of the modules can be combined into a single module.

The parser 1690 (or entropy decoder) receives the bitstream 1695 and performs initial parsing according to the syntax defined by a video-coding or image-coding standard. The parsed syntax element includes various header elements, flags, as well as quantized data (or quantized coefficients) 1612. The parser 1690 parses out the various syntax elements by using entropy-coding techniques such as context-adaptive binary arithmetic coding (CABAC) or Huffman encoding.

The inverse quantization module 1611 de-quantizes the quantized data (or quantized coefficients) 1612 to obtain transform coefficients, and the inverse transform module 1610 performs inverse transform on the transform coefficients 1616 to produce reconstructed residual signal 1619. The reconstructed residual signal 1619 is added with predicted pixel data 1613 from the intra-prediction module 1625 or the motion compensation module 1630 to produce decoded pixel data 1617. The decoded pixels data are filtered by the in-loop filter 1645 and stored in the decoded picture buffer 1650. In some embodiments, the decoded picture buffer 1650 is a storage external to the video decoder 1600. In some embodiments, the decoded picture buffer 1650 is a storage internal to the video decoder 1600.

The intra-prediction module 1625 receives intra-prediction data from bitstream 1695 and according to which, produces the predicted pixel data 1613 from the decoded pixel data 1617 stored in the decoded picture buffer 1650. In some embodiments, the decoded pixel data 1617 is also stored in a line buffer (not illustrated) for intra-picture prediction and spatial MV prediction.

In some embodiments, the content of the decoded picture buffer 1650 is used for display. A display device 1655 either retrieves the content of the decoded picture buffer 1650 for display directly, or retrieves the content of the decoded picture buffer to a display buffer. In some embodiments, the display device receives pixel values from the decoded picture buffer 1650 through a pixel transport.

The motion compensation module 1630 produces predicted pixel data 1613 from the decoded pixel data 1617 stored in the decoded picture buffer 1650 according to motion compensation MVs (MC MVs). These motion compensation MVs are decoded by adding the residual motion data received from the bitstream 1695 with predicted MVs received from the MV prediction module 1675.

The MV prediction module 1675 generates the predicted MVs based on reference MVs that were generated for decoding previous video frames, e.g., the motion compensation MVs that were used to perform motion compensation. The MV prediction module 1675 retrieves the reference MVs of previous video frames from the MV buffer 1665. The video decoder 1600 stores the motion compensation MVs generated for decoding the current video frame in the MV buffer 1665 as reference MVs for producing predicted MVs.

The in-loop filter 1645 performs filtering or smoothing operations on the decoded pixel data 1617 to reduce the artifacts of coding, particularly at boundaries of pixel blocks. In some embodiments, the filtering or smoothing operations performed by the in-loop filter 1645 include deblock filter (DBF), sample adaptive offset (SAO), and/or adaptive loop filter (ALF).

FIG. 17 illustrates portions of the video decoder 1600 that implement out-of-bound checks for predictive coding. Specifically, the FIGURE illustrates the components of the motion compensation module 1630 of the video decoder 1600.

As illustrated, the motion compensation module 1630 has a candidate selector 1710 that selects block vectors (including motion vectors and intra prediction modes) from the MV buffer 1665 and the intra prediction module 1625. The selection is provided by the entropy decoder 1690 based on syntax elements parsed from the bitstream 1695. The selected block vectors are examined by a OOB check module 1730, which determines whether the reference blocks identified by the block vectors are out-of-bound. The selected block vectors are also provided to a prediction generator module 1720.

The prediction generator module 1720 generates a predictor or prediction block for the current block as the predicted pixel data 1613 by fetching samples from the decoded picture buffer 1650. The entropy decoder 1690 selects one or more prediction coding tools for the current block (e.g., bi-prediction, GPM, CIIP, MHP, intra-prediction, IBC, etc.), and the prediction generator module 1720 generates the predictor based on the selected prediction tool(s).

The predictor generator module 1720 also uses the OOB check result from the OOB check module 1730 to determine whether to exclude certain reference samples identified by the selected block vector(s) when performing blending to generate the predictor. For example, if the current picture is an ERP picture and the reference block identified by the block vector has OOB samples, the predictor generator module 1720 may use the horizontal wrap-around samples fetched from the decoded picture buffer 1650 for blending if the reference block is OOB at the left or right boundary, or exclude the OOB samples from blending if the reference block is OOB at the top or bottom boundary. The predictor generator module 1720 may also use the OOB result to determine whether to exclude samples from BM cost calculation or TM cost calculation.

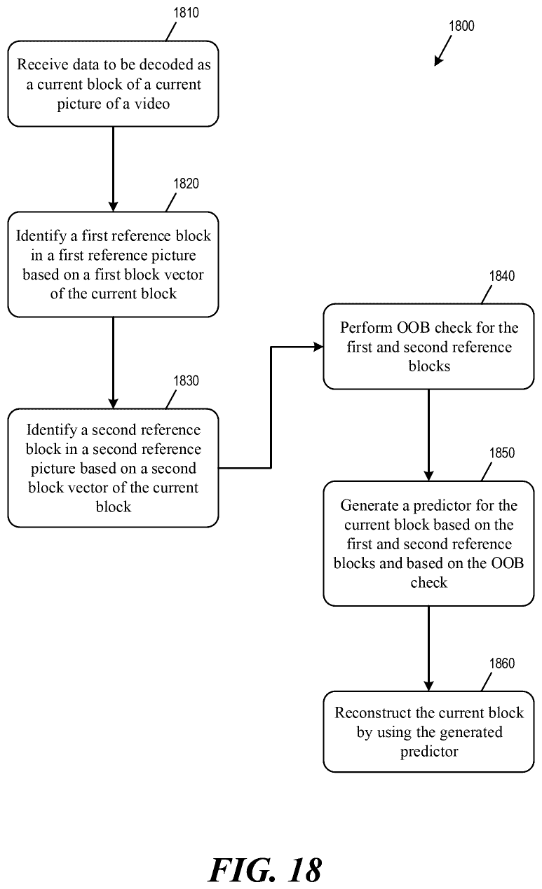

FIG. 18 conceptually illustrates a process 1800 for using out-of-bound checks for predictive coding of a block of pixels. In some embodiments, one or more processing units (e.g., a processor) of a computing device implementing the decoder 1600 performs the process 1800 by executing instructions stored in a computer readable medium. In some embodiments, an electronic apparatus implementing the decoder 1600 performs the process 1800.

The decoder receives (at block 1810) data to be decoded as a current block of pixels in a current picture of a video. The decoder identifies (at block 1820) a first reference block in a first reference picture based on a first block vector of the current block. The decoder identifies (at block 1830) a second reference block in a second reference picture based on a second block vector of the current block. The first and second block vectors may be motion vectors. In some embodiments, the first reference picture or the second reference picture is the current picture, and the first block vector or the second block vector is an intra-prediction direction or mode.

The decoder performs (at block 1840) out-of-bound (OOB) check for the first and second reference blocks. The decoder generates (at block 1850) a predictor for the current block based on the first and second reference blocks and based on the OOB check. In some embodiments, when a sample of the first reference block is OOB, a bi-directional motion compensation is not applied to at least one of a horizontal direction and a vertical direction. In some embodiments, when a sample of the first reference block is OOB over a left or right boundary of the first reference picture or when a sample of the first reference block is OOB over a top or bottom boundary of the first reference picture, the bi-directional motion compensation is not applied. In some embodiments, when a sample of the first reference block is a non-OOB sample, a corresponding predictor sample is generated by blending the non-OOB sample of the first reference block with a corresponding non-OOB sample of the second reference block. When a sample of the first reference block is a OOB sample, a corresponding predictor sample is generated by using a corresponding non-OOB sample of the second reference block without blending.

In some embodiments, the video may be a 360-degree video in an equi-rectangular projection (ERP) format. When a sample of the first reference block is OOB over a left or right boundary of the first reference picture, a corresponding predictor sample is generated by blending a horizontal wrap-around sample from the first reference picture with a corresponding non-OOB sample from the second reference block in the second reference picture. When a sample of the first reference block is OOB over a top or bottom boundary of the first reference picture, a corresponding predictor sample is generated by using a corresponding non-OOB sample from the second reference block without blending.

In some embodiments, the current block is partitioned into multiple geometric partitions, the first reference block is used to generate a first predictor for a first geometric partition and the second reference block is used to generate a second predictor for a second geometric partition. A corresponding predictor sample is generated by blending samples of the first and second predictors along a boundary between the first and second geometric partitions, with out-of-bound samples of the first and second predictors excluded from the blending.

In some embodiments, the generated predictor is a combined inter-intra prediction (CIIP), wherein the first reference block provides inter-prediction samples and the second reference block provide intra-prediction samples. In some embodiments, the current block is coded using MHP, such that the decoder performs an additional OOB check for a third reference block, and the predictor is generated further based on the third reference block and the additional OOB check.

In some embodiments, the first block vector is refined to minimize a calculated template matching cost between a reference template neighboring the first reference block and a current template neighboring the current block, with OOB samples of the reference template excluded from the cost calculation. In some embodiments, the first and second block vectors are refined to minimize a bilateral matching cost based on the first and second reference blocks, with OOB samples in the first and second reference blocks excluded from the cost calculation.

The decoder reconstructs (at block 1860) the current block by using the generated predictor. The decoder may then provide the reconstructed current block for display as part of the reconstructed current picture.

### VI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

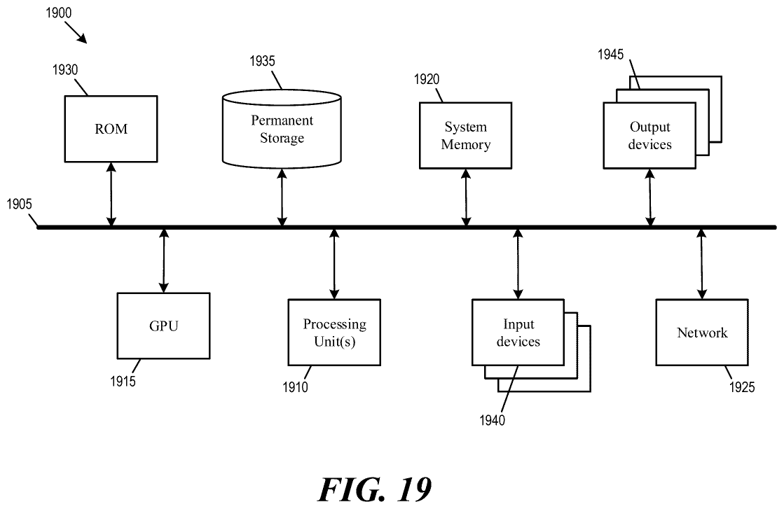

FIG. 19 conceptually illustrates an electronic system 1900 with which some embodiments of the present disclosure are implemented. The electronic system 1900 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1900 includes a bus 1905, processing unit(s) 1910, a graphics-processing unit (GPU) 1915, a system memory 1920, a network 1925, a read-only memory 1930, a permanent storage device 1935, input devices 1940, and output devices 1945.

The bus 1905 collectively represents all system, peripheral, and chipset buses that communicatively connect the numerous internal devices of the electronic system 1900. For instance, the bus 1905 communicatively connects the processing unit(s) 1910 with the GPU 1915, the read-only memory 1930, the system memory 1920, and the permanent storage device 1935.

From these various memory units, the processing unit(s) 1910 retrieves instructions to execute and data to process in order to execute the processes of the present disclosure. The processing unit(s) may be a single processor or a multi-core processor in different embodiments. Some instructions are passed to and executed by the GPU 1915. The GPU 1915 can offload various computations or complement the image processing provided by the processing unit(s) 1910.

The read-only-memory (ROM) 1930 stores static data and instructions that are used by the processing unit(s) 1910 and other modules of the electronic system. The permanent storage device 1935, on the other hand, is a read-and-write memory device. This device is a non-volatile memory unit that stores instructions and data even when the electronic system 1900 is off. Some embodiments of the present disclosure use a mass-storage device (such as a magnetic or optical disk and its corresponding disk drive) as the permanent storage device 1935.

Other embodiments use a removable storage device (such as a floppy disk, flash memory device, etc., and its corresponding disk drive) as the permanent storage device. Like the permanent storage device 1935, the system memory 1920 is a read-and-write memory device. However, unlike storage device 1935, the system memory 1920 is a volatile read-and-write memory, such a random access memory. The system memory 1920 stores some of the instructions and data that the processor uses at runtime. In some embodiments, processes in accordance with the present disclosure are stored in the system memory 1920, the permanent storage device 1935, and/or the read-only memory 1930. For example, the various memory units include instructions for processing multimedia clips in accordance with some embodiments. From these various memory units, the processing unit(s) 1910 retrieves instructions to execute and data to process in order to execute the processes of some embodiments.

The bus 1905 also connects to the input and output devices 1940 and 1945. The input devices 1940 enable the user to communicate information and select commands to the electronic system. The input devices 1940 include alphanumeric keyboards and pointing devices (also called “cursor control devices”), cameras (e.g., webcams), microphones or similar devices for receiving voice commands, etc. The output devices 1945 display images generated by the electronic system or otherwise output data. The output devices 1945 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 19, bus 1905 also couples electronic system 1900 to a network 1925 through a network adapter (not shown). In this manner, the computer can be a part of a network of computers (such as a local area network (“LAN”), a wide area network (“WAN”), or an Intranet, or a network of networks, such as the Internet. Any or all components of electronic system 1900 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the FIGURES (including FIG. 15 and FIG. 18) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of a current picture of a video;
identifying a first reference block in a first reference picture based on a first block vector of the current block;
identifying a second reference block in a second reference picture based on a second block vector of the current block;
performing out-of-bound (OOB) check for the first and second reference blocks;
generating a predictor for the current block based on the first and second reference blocks and based on the OOB check, wherein when a sample of the first reference block is OOB, a bi-directional motion compensation is not applied to at least one of a horizontal direction and a vertical direction; and
encoding or decoding the current block by using the generated predictor.

2. The video coding method of claim 1, wherein:
when a sample of the first reference block is OOB over a left or right boundary of the first reference picture, a corresponding predictor sample is generated by blending a horizontal wrap-around sample from the first reference picture with a corresponding non-OOB sample from the second reference block in the second reference picture,
when a sample of the first reference block is OOB over a top or bottom boundary of the first reference picture, a corresponding predictor sample is generated by using a corresponding non-OOB sample from the second reference block without blending.

3. The video coding method of claim 2, wherein the video is a 360-degree video in an equi-rectangular projection (ERP) format.

4. The video coding method of claim 1, wherein:
when a sample of the first reference block is OOB over a left or right boundary of the first reference picture or when a sample of the first reference block is OOB over a top or bottom boundary of the first reference picture, the bi-directional motion compensation is not applied.

5. The video coding method of claim 1, wherein the first reference picture or the second reference picture is the current picture.

6. The video coding method of claim 5, wherein the first block vector or the second block vector is an intra-prediction direction.

7. The video coding method of claim 1, wherein:
the current block comprises a plurality of geometric partitions,
the first reference block is used to generate a first predictor for a first geometric partition,
the second reference block is used to generate a second predictor for a second geometric partition,
wherein a corresponding predictor sample is generated by blending samples of the first and second predictors along a boundary between the first and second geometric partitions, wherein out-of-bound samples of the first and second predictors are excluded from the blending.

8. The video coding method of claim 1, wherein the generated predictor is a combined inter-intra prediction (CIIP), wherein the first reference block provides inter-prediction samples and the second reference block provide intra-prediction samples.

9. The video coding method of claim 1, further comprising performing an additional OOB check for a third reference block, wherein the predictor is generated further based on the third reference block and the additional OOB check.

10. The video coding method of claim 1, wherein the first block vector is refined to minimize a calculated template matching cost between a reference template neighboring the first reference block and a current template neighboring the current block, wherein OOB samples of the reference template are excluded from the cost calculation.

11. The video coding method of claim 1, wherein the first and second block vectors are refined to minimize a bilateral matching cost based on the first and second reference blocks, wherein OOB samples in the first and second reference blocks are excluded from the cost calculation.

12. An electronic apparatus comprising:
a video coder circuit configured to perform operations comprising:
receiving data to be encoded or decoded as a current block of a current picture of a video;
identifying a first reference block in a first reference picture based on a first block vector of the current block;
identifying a second reference block in a second reference picture based on a second block vector of the current block;
performing out-of-bound (OOB) check for the first and second reference blocks;
generating a predictor for the current block based on the first and second reference blocks and based on the OOB check, wherein when a sample of the first reference block is OOB, a bi-directional motion compensation is not applied to at least one of a horizontal direction and a vertical direction; and
encoding or decoding the current block by using the generated predictor.

13. A video decoding method comprising:
receiving data to be decoded as a current block of a current picture of a video;
identifying a first reference block in a first reference picture based on a first block vector of the current block;
identifying a second reference block in a second reference picture based on a second block vector of the current block;
performing out-of-bound (OOB) check for the first and second reference blocks;
generating a predictor for the current block based on the first and second reference blocks and based on the OOB check, wherein when a sample of the first reference block is OOB, a bi-directional motion compensation is not applied to at least one of a horizontal direction and a vertical direction; and
reconstructing the current block by using the generated predictor.
